(19) United States
(12) Patent Application Publication
(10) Pub. No.: US 2005/0075898 A1
(43) Pub. Date: Apr. 7, 2005

(54) Method and system for obtaining and financing exclusive real estate listings

(76) Inventors: Jack Wasserman, Southampton, NY (US); William Campbell, Ridgewood, NJ (US)

Correspondence Address: Steven B. Pokotilow;Stroock & Stroock & Lavan LLP, 180 Maiden Lane, New York, NY, 10038, US

(21) Appl. No.: 10/733,481

(22) Filed: Dec. 11, 2003

Related U.S. Application Data
(63) Continuation-in-part of application No. 10/678,871, filed on Oct. 3, 2003.

(51) Int. Cl. G06F 17/60

(52) U.S. Cl. 705/1

(57) ABSTRACT

A method of obtaining a seller's exclusive real estate listing for a property. The method comprises providing consideration to the seller, for example, in the form of an up-front payment, and receiving from the seller an option to purchase the property and the exclusive real estate listing of the property, the exclusive real estate listing being for an exclusivity time period. If a sale condition, such as receipt of a bona fide purchase offer or a contract for sale, for the property is met during the exclusivity time period, the real estate agent receives return consideration, such as a refund of at least a portion of the consideration.

### CROSS REFERENCE TO RELATED APPLICATIONS

This application is a continuation-in-part of U.S. application Ser. No. 10/678,871, filed Oct. 3, 2003, entitled METHOD AND SYSTEM FOR OBTAINING AND FINANCING EXCLUSIVE REAL ESTATE LISTINGS, which application is hereby incorporated herein by reference.

### BACKGROUND OF THE INVENTION

1. Field of the Invention

The present invention relates generally to real estate transactions and, more specifically, to methods and systems for real estate agents to obtain and/or finance exclusive real estate listings.

2. Description of Related Art

In the current residential real estate industry, real estate companies offer home owners essentially two options to sell their properties: either an exclusive listing of the property or a non-exclusive listing. An exclusive contract, or listing, involves a contractual arrangement between the real estate company and seller pursuant to which the company has the exclusive right to sell the property for a specified duration of time, typically a number of months. A non-exclusive arrangement, on the other hand, permits the seller to hire other real estate companies to sell the property. In return for listing the property, the real estate company, and the agents working for them, obtain a commission, usually a percentage of the selling price of the property.

The real estate company much prefers an exclusive listing. With an exclusive listing, the real estate company is more likely to recoup its investment in advertising, or listing, the property. However, there is a tension between the real estate company's goal of obtaining an exclusive listing and the seller's desire. Sellers frequently believe that an exclusive listing is disadvantageous: with only one company advertising and showing the property, fewer potential buyers view the property. With fewer buyers, selling the property is less likely and, if the property is sold, the lack of competition is likely to result in a lower selling price.

Accordingly, there exists a need for an improved method for listing real estate properties and, more specifically, for exclusive listings.

### SUMMARY OF THE INVENTION

The present invention satisfies the foregoing, as well as other, needs. A method of obtaining a seller's exclusive real estate listing for a property according to one embodiment includes a real estate agent providing consideration to the seller, for example, in the form of an up-front payment, and receiving from the seller the exclusive real estate listing of the property, the exclusive real estate listing being for an exclusivity time period. If a sale condition, such as receipt of a bona fide purchase offer or a contract for sale, is met during the exclusivity time period, the real estate agent will receive return consideration, such as a refund of at least a portion of the consideration. To protect the real estate agent from a seller refusing to sell the property, and thereby help ensure the real estate agent receives its commission, the seller also provides the real estate agent with an option to purchase the property. The option, preferably is recordable against the property and may be assigned. In embodiments where the real estate agent uses a financing agent to finance the seller's contracts, the option also provides the financing agent of the real estate agent greater security that the real estate agent will be able to repay its financing.

### BRIEF DESCRIPTION OF THE DRAWINGS

The following drawings, which form a part hereof and are attached hereto, are exemplary in nature and are not to be limiting of the scope of the invention, which is set forth in the claims hereto.

FIG. 1 is a schematic illustrating the method according to one embodiment of the present invention.

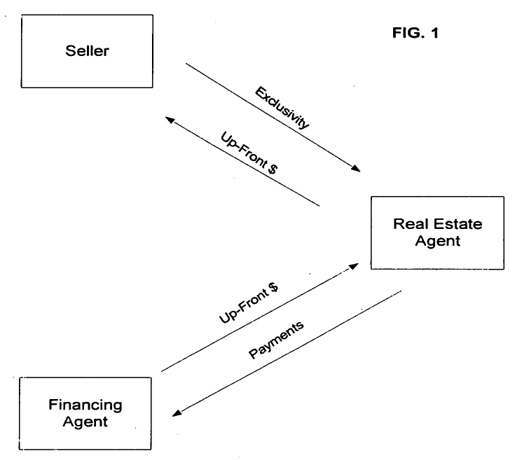

FIG. 2a is a table illustrating exemplary financials associated with in-house sales according to one embodiment of the present invention.

FIG. 2a is a table illustrating exemplary financials associated with co-brokered sales according to one embodiment of the present invention.

### DETAILED DESCRIPTION OF CERTAIN EMBODIMENTS

Certain embodiments of the present invention will now be described with reference to the foregoing figures. As an initial matter, although the embodiments disclosed herein are described in the context of residential real estate, it is to be understood that the present invention is applicable to all types of real estate, including, for example, commercial real estate, land, single family homes, condominiums, cooperatives, rental properties, and the like.

In general, the present embodiment provides for a contractual arrangement between the seller (or seller's agent) and real estate agent (which is meant to encompass companies and other real estate entities), pursuant to which the seller grants the agent an exclusive for the seller's property, as well as a contractual arrangement between the agent and a financing agent, pursuant to which the agent finances its arrangement with the seller.

More specifically, the seller and real estate agent enter a contract (referred to herein as a “seller's contract”) pursuant to which the seller grants the agent an exclusive right to sell and otherwise list the seller's property. Such exclusivity preferably is for a fixed amount of time, for example, between three and eighteen months, although the exclusivity time period may be longer, for example, until a sale condition (as described below) is satisfied. In return, the real estate agent gives the seller consideration for the grant of exclusivity, thereby providing the seller with an incentive to grant the real estate agent the exclusive listing. In the present embodiment, the consideration is in the form of an up-front payment, although other consideration may be used, such as one or more payments over time, goods, services, and other types of consideration.

The contract further provides that the seller may keep the payment if the agent fails to sell the property and must provide the real estate agent with return consideration if the agent sells the property. It is to be understood that the contract may define any other sale condition as triggering the return consideration, including, for example, the seller receiving a bona fide offer, the seller being under contract to sell the property, and the like. Furthermore, the occurrence of a sale condition may occur during the exclusivity time period or after the period, for example, where, after the exclusivity time period expires, a bona fide offer is received from, or a contract for sale is entered with, a buyer that the real estate agent originally introduced to the seller/property during the exclusivity time period. In the event the property is sold during the term of exclusivity specified in the contract, the seller refunds the payment. Thus, in the present embodiment, at least a portion of the consideration provided to the seller is a payment contingent upon the failure to satisfy the sale condition for the property.

The return consideration may take any number of forms, including, for example, the seller providing the real estate agent a full or partial refund of the consideration given to the seller. Rather than returning the payment (or other consideration), the real estate agent may simply include terms in the seller's contract providing for an accounting at closing of the sale, whereby the purchase price is offset with the amount to be refunded. The contract may provide for all or a portion of the up-front payment to the seller to be held in escrow to ensure all or a portion is available to be refunded. In certain embodiments, the consideration to the seller is an advance of a portion of the listing, market or anticipated sale price of the property; if the sale condition is not satisfied, the seller retains the advance. In still other embodiments, in the event the real estate agent satisfies the sale condition, the return consideration takes the form of an increased commission.

It should be understood that in certain embodiments the seller does not return (or have offset) the entire amount received from the real estate agent. For example, in certain embodiments, as an added incentive to provide the exclusive listing, the seller is able to retain a portion of the consideration.

Although not required, in the present embodiment, in the seller's contract, the seller also grants to the real estate agent an option for the real estate agent to transfer the subject property, such as a right for the agent to purchase the property or to proceed with the sale of the property on behalf of the seller. The option is exercisable upon the occurrence of any one or more option conditions specified in the seller's contract. Such option conditions include, for example, the seller refusing to sell to a bona fide purchaser identified by the real estate agent. Depending upon the condition, the contract could also specify what constitutes a bona fide purchaser or purchase offer, including, for example, the amount, the timing (for example, a number of weeks or months into the listing contract, or some bona fide purchaser other than the first, thereby protecting the seller from having to accept the first purchase offer and from having the property priced below market value), one or more terms of the sale (for example, closing date, the real estate agent having found the seller another home, and the like). The seller's contract may also specify the conditions pursuant to which the real estate agent could sell the property when exercising the option, including, for example, the price, closing date and the like.

The contract may also set forth procedures for the real estate agent (or its assigns) remitting proceeds from the sale to the seller in the event the option is exercised. Such accounting could take into consideration the real estate agent's commission and return consideration.

Preferably, the option represents an interest in the property that can be recorded in accordance with relevant laws and regulations.

The option is also preferably assignable to the real estate agent's financing agent, as discussed below. Alternatively, the seller grants the option directly to the financing agent.

As will be appreciated, the option provides the real estate agent with an additional level of protection against a seller that refuses to sell its property. In the event a seller refuses to sell the property, the real estate agent risks losing (or at least having to await receipt of) both the return consideration and its commission for sale of the property. More problematic, the seller might attempt to sell the property to a third party without the knowledge of the real estate agent. Because the option is a recordable interest, any attempted sale would likely be unsuccessful, as the third party purchaser's title search would uncover the recorded option. Similarly, regardless of whether the contract includes the option grant, the contract may provide a grant to the agent of a lien and/or security interest in the property to secure the agent's return consideration, commission, or both.

As also will be appreciated by those skilled in the art, the real estate agent recognizes a benefit not only from executing seller's contracts, but also from being able to offer seller's contracts as an alternative to traditional listing contracts with sellers. For example, because the seller's contract provides the seller with the potential of receiving the consideration, the real estate agent is justified in charging a higher commission in connection with the seller's contract, as compared to traditional exclusive listing contracts offered by the real estate agent. Conversely, if potential sellers believe the commission associated with the seller's contract is too high, the real estate agent can offer the lower commission, standard contract. Similarly, the ability of the real estate agent to offer seller's contracts both with and without the option provides benefits, namely, the ability to justify a higher commission for those contracts not granting the option. Thus, if potential sellers believe the commissions of the seller's contract is too high, then the real estate agent could offer the contract with a lower commission, but with the option.

Having described the terms of the seller's contract according to various illustrative embodiments, a specific example of a form seller's contract will now be described. The form seller's contract (which includes typical terms not required for the present invention) reads as follows, where “you” refers to the seller and “us” refers to the real estate agent and where the specified values are merely examples and the blanks would be negotiated terms:
(a) You have employed us as real estate brokers with the exclusive right to sell the property located at ______ (the “Property”). You represent that you are the owner of the Property.
(b) This agreement shall be in effect as of ______and shall continue in full force and effect until ______ (the “Term”).
(c) We are authorized to offer the Property for sale on your behalf at a price of $______ (the “Offer Price”)
(d) We have the sole authorization to solicit the cooperation of other licensed real estate brokers and to work with them on a cooperating basis for the sale of the Property. If the Property is sold by us pursuant to this agreement, our commission to be paid by you shall be ______ (______%) percent of the total sales price (“Sales Price”) of the Property, or $______, which ever is greater (the “Commission”). In the event another licensed real estate broker solicited by us is involved in the transaction, we shall pay the cooperating broker a commission by separate agreement with such broker. The foregoing Commission shall be earned by us at such time as a ready, willing and able purchaser has offered to purchase the Property for a price equal to or greater than the Offer Price and otherwise on normal and customary terms for comparable properties in the general vicinity of the Property, which terms shall include a mortgage finance contingency of no more than ______% of the Sales Price. The Commission shall become due and payable at the earliest to occur of (a) your refusal to accept any such purchase offer or (b) your default under any written contract of sale or (c) the closing of such sale.
(e) During the term of this exclusive right, you agree to refer to us all inquiries, proposals and offers received by you regarding the Property, including, but not limited to those from principals and other brokers (“Owner Referrals”), and you agree to conduct all negotiations with respect to the sale or other disposition of the Property solely and exclusively through us.
(f) Within ten (10) days after the expiration of the Term, we shall deliver to you a list of no more than fifteen (15) names of persons who inspected the Property during the Term (the “List”). If within six (6) months after the expiration of the Term a contract is signed to sell the Property to a person on the List, we shall be entitled to a commission of ______ (______%) percent of the purchase price, or $______, whichever is greater.
(g) We will provide you with the names of all persons shown the Property and will specify those who made offers.
(h) In consideration of your giving us the exclusive right to sell the Property, upon execution of this agreement we shall pay you $______ (the “Consideration”). If we become entitled to the Commission, you shall be obligated to refund the Consideration to us at the same time the Commission becomes due and payable to us.
(i) You further agree that in exchange for the Consideration, you hereby grant us the option to purchase the Property at a purchase price equal to the greater of the Offer Price or the price offered by a ready, willing and able purchaser of the Property, and otherwise on normal and customary terms for the sale of comparable properties. The foregoing option shall expire at the end of the Term, except that the option shall continue to be available to us for six (6) months after the Term if any Owner Referrals or any persons on the List offer to purchase the Property within such six (6) month period. If we purchase the Property, you shall refund the Consideration to us and the Commission shall be due and payable by you to us at the time of purchase.
(j) You hereby mortgage, convey and grant to us a lien and security interest on the Property to secure any obligation that you may have to refund the Consideration or to pay us the Commission.
(k) You hereby represent and warrant to us that you are not aware of any fact or circumstance that may prevent the Property from being sold at the Offer Price during the Term. We acknowledge that your representation shall not be deemed to extend to the market value of the Property or to general market conditions.
(l) This agreement shall bind and benefit the personal representatives, successors or assigns of the parties.
(m) Your agree that any controversy or claim relating to this agreement shall be settled by binding arbitration in accordance with the rules of the American Arbitration Association.
(n) This agreement may not be changed, rescinded, or modified except in writing, signed by both of us.
(o) If the foregoing meets with your approval please sign and return the enclosed copy of this agreement.

The consideration and return consideration are set forth in paragraphs (d) and (h). Paragraph (h) establishes the Consideration being paid to the seller and the return consideration being paid to the real estate agent. The sale condition triggering the return consideration is the entitlement to the Commission, namely, as set forth in paragraph (d), the seller's refusal to accept a purchase offer from a ready, willing and able purchaser who has offered to purchase the Property for a price equal to or greater than the Offer Price and otherwise on normal and customary terms for comparable properties in the general vicinity of the Property, which terms shall include a mortgage finance contingency of no more than a negotiated amount or the seller's default under any written contract of sale or the closing of such sale.

Paragraph (i) grants the real estate agent an option to purchase the property. The terms of the option include the price and terms on which the real estate agent may exercise the option and purchase the Property, namely “a purchase price equal to the greater of the Offer Price or the price offered by a ready, willing and able purchaser of the Property, and otherwise on normal and customary terms for the sale of comparable properties.” The option may be exercised at any time during the Term of exclusivity. Because the contract includes typical provisions for the real estate agent to receive a commission based on Owner Referrals (paragraph (e)) and people whom the agent introduced to the Property and identified on the List (paragraph (f)), the option extends for an additional six months to cover offers to purchase the Property from Owner Referrals and people on the List. If the agent exercises the option, the agent receives the return consideration (here, a complete refund of the Consideration) and its Commission.

To provide additional security to the real estate agent, the contract (paragraph (j)) also includes a grant from the seller of a lien and security interest in the Property to secure the return consideration and the Commission.

In the present embodiment, the real estate agent also enters into a contract with a financing agent (referred to herein as a “financing contract”). The financing agent may be a wholly separate agent or may be related to the real estate agent. Pursuant to the financing contract, the financing agent provides the real estate agent with a loan, in the form of an up-front payment, in return for a series of payments over time. In general, the financing contract is a mechanism by which the real estate agent finances payments to the seller under the seller's contract. As will be appreciated by those skilled in the art, each contract between the real estate agent and a financing agent may cover one or more seller's contracts.

In certain embodiments, the financing contract also provides for the assignment of the options obtained by the real estate agent on the one or more properties. For example, where the financing agreement covers listings of certain properties (e.g., specified addresses, all listings acquired during a certain time period, all listings up to a certain aggregate market value, or other identified properties), all options on such properties would be assigned.

Alternatively, the real estate agent could retain the option. In certain of such embodiments, the financing contract could obligate the real estate agent to exercise its option in properties covered by the financing agreement. Any number of conditions could be placed on such exercise of options, including whether to exercise the options, what options to exercise (e.g, up to a certain aggregate market value), when such options must be exercised and the like.

Practically, the real estate agent receives a loan from the financing agent in an amount sufficient to make payment on its outstanding or anticipated seller's contracts. The risk assumed by the financing agent depends, in part, on the likelihood of the real estate agent selling the property that is subject to the seller's contract and, based on the sale, receiving a return of the up-front payment or consideration to the seller and its negotiated sales commission. Other risk factors include the general condition of the real estate market, the financial strength of the real estate agent, whether the real estate agent has received options in the subject properties and the like. Payments to the financing agent will likely reflect these risks. The payments made by the real estate agent over time may equal a return of the principal plus an agreed to interest amount reflective of the risk assumed by the financing agent, for example 1-2% of the amount of the up-front payment.

The financing contract of the present embodiment further provides for a date upon which the financing loan becomes due. Such date may be relative to the date on which the periods of exclusivity under the real estate agent's contracts with one or more sellers expire, may be based on certain calendar dates, such as quarterly, bi-annually, annually, or any other negotiated date. Any portion of the loan payments due to the financing agent may be payable at the due date, as reflected in the financing contract.

In other embodiments, the payments from the real estate agent may equal a percentage of the real estate agent's anticipated commissions from the sale of properties covered by one or more seller's contracts. In return for an up-front financing payment, the financing agent has a contractual right to a portion of the future cash flow of the real estate agent. As such, the financing agent assumes a role similar to that of a factor.

The financing agent may simply collect its portion of these future payments, or it may issue derivative securities based on these future payments. Such derivatives may be segregated into any of a number of pools or traunches, for example, by date of expiration of the underlying seller's contracts, geographic market of the properties being sold, market value of properties being sold, type of property being sold, particular real estate agent, the interest rate charged by the financing agent and the like.

It should be understood that although the primary embodiment has been described in the context of a single seller and real estate agent, it is equally applicable to the agent contracting with multiple potential sellers. Similarly, although a single financing agent is described as contracting with one real estate agent, the present embodiment is applicable to one or more financing agents contracting with one or more real estate companies. Indeed, it is anticipated that a single financing agent will contract with multiple real estate companies, thereby diversifying its risk. Also, there is no requirement that a real estate agent use a financing agent or otherwise obtain financing.

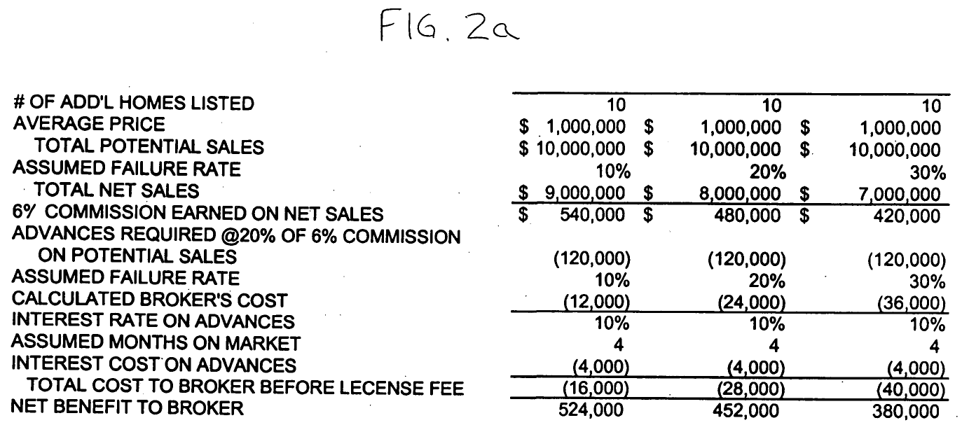

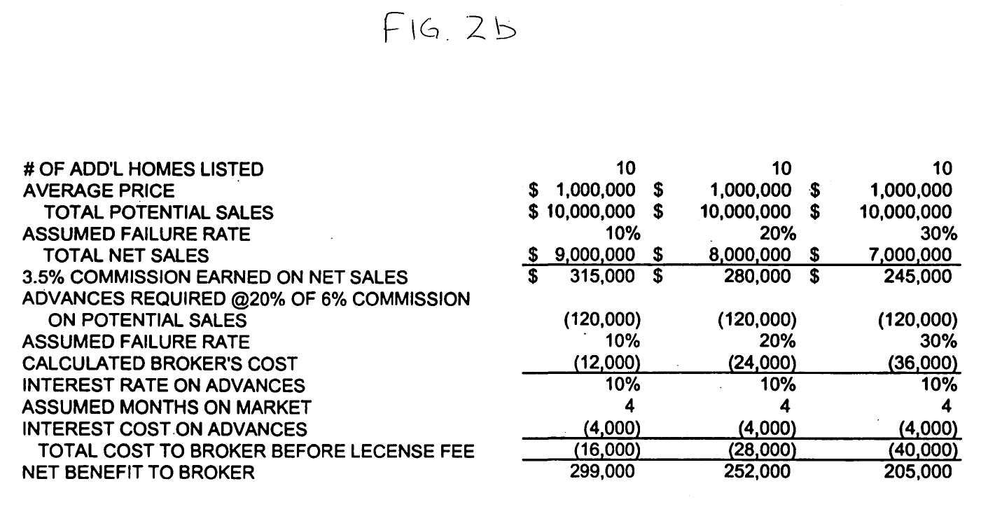

Turning now to FIG. 2a, exemplary financials of one embodiment of the present invention will now be discussed. The financials illustrated assumes in-house sales by the real estate agent (i.e., no co-broker sales), an average selling price of one million dollars, the real estate agent receiving exclusive listings for ten additional homes, a commission of six percent of sale price, up-front consideration to the seller of twenty percent of the six percent commission and, in each of three columns, a percentage rate of failure to make the sale within the exclusivity period of ten, twenty and thirty percent, respectively. As shown, even with a failure rate of thirty percent, on ten sales the real estate agent has a net benefit of $380,000 dollars on just ten additional listings.

FIG. 2b illustrates exemplary financials when the real estate agent must split the commission in a co-broker sale, the real estate agent retaining three and a half percent commission. Still, even with a thirty percent failure rate, the real estate agent has a net increase of $205,000 on just ten additional listings.

It should be understood that the embodiments described herein, as well as others, can be implemented in large part by a computer system. For example, the real estate agent may utilize a specially programmed computer to track seller's and financing contracts, as well as its performance in selling properties by the termination of their respective exclusivity periods. One such computer implementation includes a programmed personal computer or server having associated electronic storage. The electronic storage includes a database for storing the details of the seller's and financing contracts. More specifically, the database includes one or more tables and fields for: identifying each seller's contract and, for each such contract, specifying the seller, seller's property, period of exclusivity and termination of such period, amount of the payment to the seller, negotiated commission, and any other parameters of the contract deemed relevant; and identifying each financing contract and, for each such contract, specifying the financing agent, the amount received, the payments owed and any other parameters deemed relevant. Where a financing contract relates to one or more specific seller's contracts, the database also indicates such relationships.

A program running on the computer provides certain functionality. For example, the program provides an information entry screen through which employees enter contract information. The program also causes the computer to run various reports, including summaries of payments due, exclusivity expiration dates, exclusivity expiration dates for properties not yet sold, sales made, commissions earned, commissions collected, and any other reports deemed relevant. The program may also include a payment system for automatically generating checks payable to one or more financing agents.

The financing agent may also implement certain functionality in a similar computer system, for example, to track its financing contracts with one or more real estate companies and the underlying seller's contracts.

Those skilled in the art will recognize that the method and system of the present invention has many applications, may be implemented in many manners and, as such, is not to be limited by the foregoing exemplary embodiments and examples. In this regard, any number of the features of the different embodiments described herein may be combined into one single embodiment. Moreover, the scope of the present invention covers conventionally known and future developed variations and modifications to the system components described herein, as would be understood by those skilled in the art.

1. A method for a real estate agent to obtain an exclusive real estate listing for a property of a seller, the method comprising:
receiving from the seller an option to purchase the property and the exclusive real estate listing of the property, the exclusive real estate listing being for an exclusivity time period.

2. The method of claim 1 further comprising:
providing consideration to the seller in return for receiving the exclusive real estate listing; and
receiving return consideration from the seller if a sale condition for the property is met during the exclusivity time period.

3. The method of claim 2, wherein the consideration includes an up-front payment to the seller.

4. The method of claim 2, wherein the sale condition is receipt of a bona fide offer to purchase the property.

5. The method of claim 2, wherein the sale condition is an executed purchase contract.

6. The method of claim 2, further comprising not receiving the return consideration refund if the sale condition is not met.

7. The method of claim 2, wherein receiving return consideration includes receiving a refund of at least a portion of the consideration.

8. The method of claim 2, wherein receiving return consideration offsetting a purchase price for the property with the refund.

9. The method of claim 2, wherein receiving return consideration includes the real estate agent increasing a commission received from the seller.

10. The method of claim 2, wherein the property has an associated price and providing consideration to the seller includes providing an advance of the price, and wherein receiving return consideration includes offsetting monies provided to the seller based on sale of the property by the advance.

11. The method of claim 2, wherein:
the providing consideration includes providing consideration to a plurality of sellers;
the receiving exclusive listing includes receiving an exclusive listing from the plurality of sellers; and
the receiving a refund includes receiving a refund from a group of the plurality of sellers for which a corresponding sale condition is met.

12. The method of claim 11, the consideration not being included in the first arrangement and the plurality of sellers have different exclusivity time periods.

13. The method of claim 11 wherein the group of sellers have different sale conditions.

14. The method of claim 1, further comprising receiving financing from a financing agent.

15. The method of claim 14, further comprising using the financing to provide consideration to the seller.

16. The method of claim 14, further comprising making payment in return for receiving the financing.

17. The method of claim 16, wherein the payment in return for the financing includes paying a percentage of the financing.

18. The method of claim 16, wherein the payment in return for the financing includes paying a percentage of commissions for sale of one or more properties.

19. The method of claim 1 wherein the option provides the real estate agent a right to purchase the property if the seller refuses to sell to a bona fide purchaser.

20. The method of claim 19, wherein the bona fide purchaser offers to purchase the property at a price or better.

21. The method of claim 19, wherein the option provides the real estate agent the right to purchase the property after a time period.

22. The method of claim 1 further comprising:
exercising the option for purchase of the property;
selling the property; and
remitting the proceeds to the seller.

23. The method of claim 1 further comprising recording the option against the property.

24. A method of a financing agent financing exclusive real estate listings, the method comprising:
providing up-front financing to a real estate agent, the real estate agent having one or more exclusive listings from sellers for sale of property pursuant to which the real estate agent receives payment from sellers upon sale of the properties;
receiving an option to transfer ownership in the property; and
receiving from the real estate agent a portion of the payment.

25. The method of claim 24, further comprising receiving from the real estate agent interest payments.

26. The method of claim 24, wherein the option is received from the real estate agent.

27. A method of claim 24, wherein the option is received from the seller.

28. A method of a real estate agent to obtain an exclusive real estate listing for a property of a seller, the method comprising:
offering the seller a first arrangement wherein the real estate agent obtains the exclusive listing for the property and a first commission; and
offering the seller a second arrangement, wherein the real estate agent obtains the exclusive listing for the property, a second commission and an option to purchase the property, and wherein the seller receives consideration for providing the exclusive listing, the option and the consideration not being included in the first arrangement.

29. The method of claim 28, wherein the first commission is less than the second commission.

30. The method of claim 28, further comprising offering the seller a third arrangement, wherein the real estate agent obtains the exclusive listing for the property and a third commission, the option not being included in the third arrangement and wherein the second commission is less than the third commission.
